(19) United States
(12) Patent Application Publication
(10) Pub. No.: US 2019/0143940 A1
(43) Pub. Date: May 16, 2019

(54) VALET KEY AND METHOD FOR CONTROLLING VALET KEY

(71) Applicant: KABUSHIKI KAISHA TOKAI RIKA DENKI SEISAKUSHO, Aichi (JP)

(72) Inventors: Yuichi INAMI, Aichi (JP); Masahiko OYA, Aichi (JP); Masahiro ARAKAWA, Aichi (JP); Yutaka KUBO, Aichi (JP)

(73) Assignee: KABUSHIKI KAISHA TOKAI RIKA DENKI SEISAKUSHO, Aichi (JP)

(21) Appl. No.: 16/181,983

(22) Filed: Nov. 6, 2018

(30) Foreign Application Priority Data
Nov. 14, 2017 (JP) 2017-219256

(51) Int. Cl. B60R 25/24; B60R 25/01; H04L 9/08

(52) U.S. Cl. CPC B60R 25/241; H04L 9/0819; B60R 25/01

(57) ABSTRACT

A valet key that is usable as a vehicle key when lending a vehicle to a third person includes an operation error monitoring unit and a notification unit. The operation error monitoring unit is configured to monitor whether or not an operation error has occurred in a user operation performed to actuate the vehicle. The notification unit is configured to have an output device issue a notification corresponding to the operation error, when the operation error monitoring unit determines that the operation error has occurred, by transmitting the operation error to the output device through a communication protocol allowing for communication with numerous unspecified communication peers.

### CROSS-REFERENCE TO RELATED APPLICATIONS

This application is based upon and claims the benefit of priority from prior Japanese Patent Application No. 2017-219256, filed on Nov. 14, 2017, the entire contents of which are incorporated herein by reference.

### FIELD

This disclosure relates to a valet key used as a vehicle key when lending a vehicle to a third person and a method for controlling a valet key.

### BACKGROUND

Japanese Laid-Open Patent Publication No. 2006-225976 discloses an electronic key system applicable to, for example, valet parking service in which a user lends the vehicle to a third person such as a valet. In such type of valet parking service, for example, the user hands a dedicated valet key to the third person in order to have the vehicle parked at a certain parking spot.

### SUMMARY

The valet key may be switched between a state in which the function of the valet key is valid and a state in which the function of the value key is invalid to improve security or reduce power consumption. When the valet key is in the invalid state, the vehicle cannot be actuated even when the valet key is operated. However, when the user is not familiar with the operation procedure of the valet key, the user may become confused not knowing why the vehicle cannot be actuated. Thus, it is desirable that the user be notified of an error in a user operation.

One embodiment is a valet key that is usable as a vehicle key when lending a vehicle to a third person includes an operation error monitoring unit and a notification unit. The operation error monitoring unit is configured to monitor whether or not an operation error has occurred in a user operation performed to actuate the vehicle. The notification unit is configured to have an output device issue a notification corresponding to the operation error, when the operation error monitoring unit determines that the operation error has occurred, by transmitting the operation error to the output device through a communication protocol allowing for communication with numerous unspecified communication peers.

One embodiment is a method for controlling a valet key usable as a vehicle key when lending a vehicle to a third person. The method includes monitoring whether or not an operation error has occurred in a user operation performed to actuate the vehicle. The method further includes having an output device issue a notification corresponding to the operation error, when determined that the operation error has occurred, by transmitting the operation error to the output device through a communication protocol allowing for communication with numerous unspecified communication peers.

Other embodiments and advantages thereof will become apparent from the following description, taken in conjunction with the accompanying drawings, illustrating by way of example the principles of the invention. It is to be understood that both the foregoing general description and the following detailed description are exemplary and explanatory and are not restrictive of the invention, as claimed.

### BRIEF DESCRIPTION OF THE DRAWINGS

The embodiments, together with objects and advantages thereof, may best be understood by reference to the following description of the presently preferred embodiments together with the accompanying drawings in which:

FIG. 1 is a schematic block diagram illustrating one embodiment of a car sharing system (valet key);

FIG. 2 is a diagram illustrating the communication sequence for code information authentication;

FIG. 3 is a diagram illustrating an example of a case in which a vehicle is operated with a mobile terminal;

FIG. 4 is a diagram illustrating an example of an operation error notification transmitted from the valet key;

FIG. 5 is a diagram illustrating another example of an operation error notification transmitted from the valet key; and

FIG. 6 is a diagram illustrating a further example of an operation error notification transmitted from the valet key.

### DESCRIPTION OF THE EMBODIMENTS

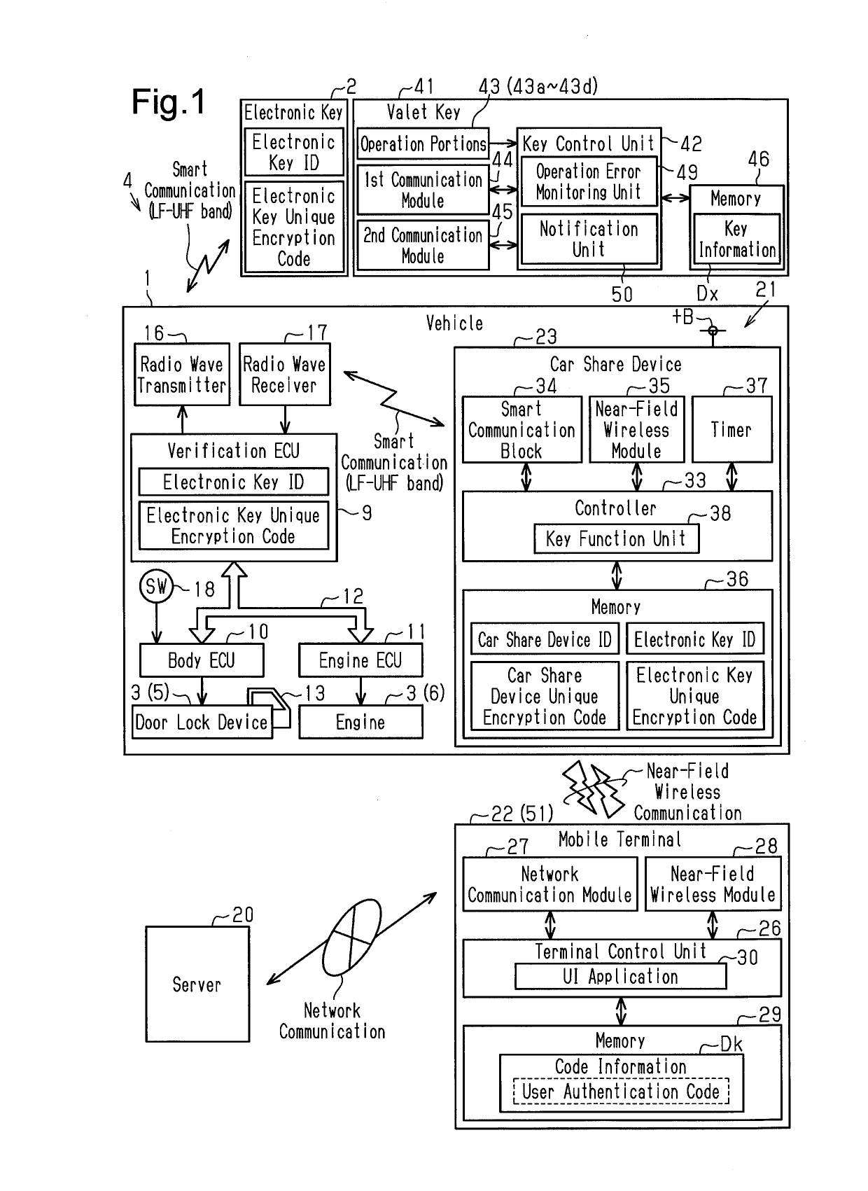

One embodiment of a valet key and a method for controlling the valet key will now be described with reference to FIGS. 1 to 4.

As illustrated in FIG. 1, a vehicle 1 is provided with an electronic key system 4. In one embodiment, the electronic key system 4 includes an electronic key 2 (vehicle key) and a verification electronic control unit (ECU) 9 that verifies the ID of the electronic key 2 through wireless communication with the electronic key 2. The verification ECU 9 actuates or permits actuation of an on-board device 3 upon ID verification accomplishment of the electronic key 2. The electronic key system 4, which is a key-operation-free system, performs electronic key ID verification (also referred to as smart verification) through short range wireless communication initiated by the vehicle 1 (verification ECU 9). In the key-operation-free system, electronic key ID verification is automatically performed without directly operating the electronic key 2. The on-board device 3 may be, for example, a door lock device 5 or an engine 6.

The vehicle 1 includes the verification ECU 9, a body ECU 10 that manages the power supply for on-board electrical devices, and an engine ECU 11 that controls the engine 6. The body ECU 10 and the engine ECU 11 are each referred to as an on-board device ECU. The ECUs 9 to 11 are electrically connected to one another by a communication line 12 in the vehicle 1. The communication line 12 is, for example, a Controller Area Network (CAN), a Local Interconnect Network (LAN), or a combination of these networks. The verification ECU 9 and the electronic key 2 each include a memory (not illustrated) that stores an electronic key ID and an electronic key unique encryption code. The electronic key ID and the electronic key unique encryption code are information unique to the electronic key 2 that is registered to the vehicle 1 and used for electronic key ID verification. The body ECU 10 controls the door lock device 5 that locks and unlocks the vehicle door 13.

The electronic key system 4 further includes a radio wave transmitter 16 and a radio wave receiver 17 that are arranged in the vehicle 1. For example, the radio wave transmitter 16 may include an exterior transmitter (not illustrated) that transmits radio waves to the outside of the vehicle 1 and an interior transmitter (not illustrated) that transmits radio waves to the inside of the vehicle 1. The radio wave transmitter 16 transmits radio waves on the low frequency (LF) band. The radio wave receiver 17 receives radio waves on the ultrahigh frequency (UHF) band. Accordingly, in the electronic key system 4, the verification ECU 9 communicates with the electronic key 2 through LF-UHF bidirectional communication.

As the electronic key 2 enters a communication area formed by a wake signal on LF radio waves transmitted from the radio wave transmitter 16, the electronic key 2 receives the wake signal and shifts from a standby state to an activated state. Upon activation of the electronic key 2, the verification ECU 9 performs ID verification (smart verification) on the electronic key 2. In a non-restrictive example, the smart verification performed between the electronic key 2 and the verification ECU 9 includes electronic key ID verification that authenticates the electronic key 2 and challenge-response verification that uses the electronic key unique encryption code. The electronic key ID verification performed under a situation in which the electronic key 2 is located outside the vehicle 1 is referred to as exterior smart verification. When exterior smart verification is accomplished, the verification ECU 9 permits or performs locking or unlocking of the vehicle door 13 with the body ECU 10.

The electronic key ID verification performed under a situation in which the electronic key 2 is located inside the vehicle 1 is referred to as interior smart verification. If interior smart verification is accomplished, the verification ECU 9 permits the shifting of devices supplied with power when an engine switch 18 is operated. For example, when the engine switch 18 is operated in a state in which the brake pedal is depressed, the verification ECU 9 starts the engine 6 with the engine ECU 11.

The vehicle 1 is provided with a car sharing system 21 that allows the vehicle 1 to be shared by a number of people. In the present example, the car sharing system 21 includes a car share device 23 installed in the vehicle 1. The car share device 23 is configured to verify the electronic key ID used by the electronic key system 4 of the vehicle 1. Further, the car share device 23 is configured to establish wireless communication with a mobile terminal 22. Encrypted code information Dk obtained from, for example, an external device such as a server 20 is registered to the mobile terminal 22. When the code information Dk is registered to the mobile terminal 22, the mobile terminal 22 is associated with the vehicle 1 (car share device 23). The car share device 23 obtains the code information Dk from the mobile terminal 22 and authenticates the code information Dk. In the present example, the car share device 23 includes an encryption code (car share device unique encryption code) configured to decode the code information Dk. The code information Dk is authenticated when decoded. After the authentication process is accomplished, the car share device 23 accepts requests from the mobile terminal 22 for actuating the on-board device 3. The mobile terminal 22 may be, for example, a smartphone. Preferably, the code information Dk is, for example, a one-time key (one-time password) that can be used only once.

The car share device 23 is independent from the hardware configuration of the electronic key system 4 and can be retrofitted to the vehicle 1. The car share device 23, for example, functions as an electronic key (vehicle key) that is valid only during the reserved time of the vehicle 1 and is similar to a spare key. In the present example, the car share device 23 cooperates with the mobile terminal 22 so that the mobile terminal 22 functions as a vehicle key in place of the electronic key 2. The car share device 23 has an electronic key function that is switched between a valid state and an invalid state. A state in which the electronic key function of the car share device 23 is valid is equivalent to a state in which an electronic key exists in the vehicle 1. A state in which the electronic key function is invalid is equivalent to a state in which an electronic key does not exist in the vehicle 1. The car share device 23 is supplied with power from a battery +B of the vehicle 1.

In a non-restrictive example, the mobile terminal 22 includes a terminal control unit 26, a network communication module 27, a near-field wireless communication module 28, and a memory 29. The terminal control unit 26 controls the operation of the mobile terminal 22. The network communication module 27 is used to establish network communication between the mobile terminal 22 and an external device such as the server 20. The near-field wireless communication module 28 is used to establish near-field wireless communication between the mobile terminal 22 and the car share device 23. The memory 29 is a data rewritable memory. The mobile terminal 22 obtains the code information Dk from the server 20 with the network communication module 27 and writes the code information Dk to the memory 29. The near-field wireless communication is performed in compliance with, for example, Bluetooth (registered trademark), preferably, Bluetooth® Low Energy (BLE).

A user interface (UI) application 30 is installed in the mobile terminal 22 to manage operation of the car sharing system 21. The UI application 30 is, for example, downloaded from the server 20 and installed in the terminal control unit 26. In the present example, a user authentication code is registered to the memory 29 of the mobile terminal 22. The user authentication code is used when the mobile terminal 22 communicates with the car share device 23 of the vehicle 1 to actuate the on-board device 3 in accordance with the operation of the mobile terminal 22. The user authentication code may be included in, for example, the code information Dk. The user authentication code may be, for example, a random number of which value changes whenever generated. The user authentication code may be registered in advance to the car sharing system 21 or generated when the vehicle 1 is used.

In a non-restrictive example, the car share device 23 includes a controller 33, a smart communication block 34, a near-field wireless module 35, a memory 36, and a timer 37. The controller 33 controls operation of the car share device 23. The smart communication block 34 is used to establish smart communication (short range wireless communication) between the car share device 23 and the electronic key system 4 (verification ECU 9). The near-field wireless module 35 is used to establish near-field wireless communication between the mobile terminal 22 and the car share device 23.

The memory 36 is a data rewritable memory. The memory 36 stores a car share device ID, a car share device unique encryption code, the electronic key ID, and the electronic key unique encryption code. The car share device ID and the car share device unique encryption code are information unique to the car share device 23. The car share device unique encryption code is used to decode the code information Dk used for encrypted communication between the mobile terminal 22 and the car share device 23. The car share device unique encryption code is stored in the server 20. The mobile terminal 22 may obtain the code information Dk, which is encrypted by the car share device unique encryption code, from the server 20. The car share device ID is, for example, associated with a vehicle ID (vehicle body number). This associates the car share device 23 with the vehicle 1. As described above, the electronic key ID and the electronic key unique encryption code are information unique to the electronic key 2 and used for electronic key ID verification (in the present example, smart verification) performed with the electronic key system 4. The timer 37 manages the date and time in the car share device 23. The timer 37 is implemented by, for example, a soft timer.

The car share device 23 includes a key function unit 38 that performs electronic key ID verification (in the present example, smart verification) through smart communication established by the smart communication block 34 between the electronic key system 4 (verification ECU 9) and the car share device 23. The key function unit 38 is arranged in the controller 33. For example, the car share device 23 includes one or more processors and a memory storing one or more commands. The one or more processors execute commands so that the controller 33 functions as the key function unit 38. The key function unit 38 obtains the code information Dk from the mobile terminal 22 and authenticates the code information Dk. When authentication of the code information Dk is accomplished in a normal manner, the key function unit 38 is allowed to perform electronic key ID verification through smart communication with the verification ECU 9. For example, when the mobile terminal 22 is operated to actuate the on-board device 3, the key function unit 38 performs electronic key ID verification (in the present example, smart verification) between the car share device 23 and the verification ECU 9 through a process similar to the electronic key ID verification performed between the electronic key 2 and the verification ECU 9. When electronic key ID verification is accomplished, actuation of the on-board device 3 is performed or permitted in accordance with operation of the mobile terminal 22.

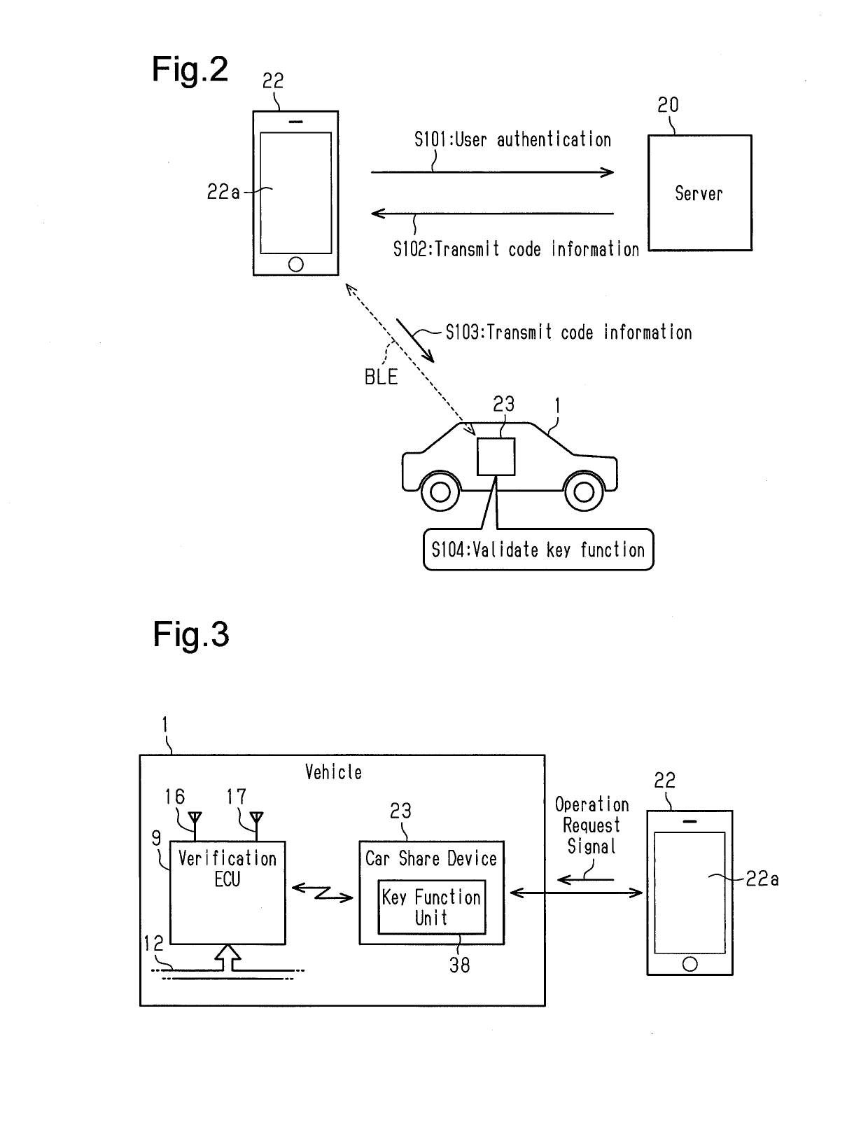

FIG. 2 illustrates an example of a communication sequence for code information authentication. When reserving the vehicle 1 with the car sharing system 21, code information authentication is performed in accordance with the communication sequence of FIG. 2. In step S101, the server 20 authenticates the user of the mobile terminal 22 (user reserving vehicle 1) through network communication with the mobile terminal 22 (the UI application 30). For example, user authentication is performed with a user ID and password that are input to the mobile terminal 22 (UI application 30). In the user authentication, a usage reservation procedure is performed to register reservation information of the vehicle 1. The reservation information of the vehicle 1 includes, for example, the reserved vehicle and the reserved date and time. After the server 20 authenticates the user with the user ID and the password, the process proceeds to step S102. If user authentication is not accomplished, the process is forcibly terminated.

In step S102, the server 20 generates the code information Dk and transmits the code information Dk to the mobile terminal 22 through network communication. For example, the car share device unique encryption code of the car share device 23, which is installed in the vehicle 1 (reserved vehicle), may be registered to the server 20. The server 20 may generate the code information Dk using the car share device unique encryption code. For example, the server 20 uses an encryption expression (encryption algorithm) to encrypt plain text with the car share device unique encryption code and use the encrypted text as the code information Dk. The encrypted plain text may include, for example, the reserved date and time of the vehicle 1, a terminal ID unique to the mobile terminal 22, and the user authentication code used as an encryption code for establishing encrypted communication between the mobile terminal 22 and the car share device 23. Further, the code information Dk may include the car share device ID.

In step S103, the mobile terminal 22 (UI application 30) establishes near-field wireless communication (in the present example, BLE) with the car share device 23 and transmits the code information Dk to the car share device 23 of the vehicle 1. For example, the Bluetooth function is validated to establish BLE communication. When receiving the car share device unique encryption code, the car share device 23 authenticates the code information Dk. In the present example, the car share device 23 uses the car share device unique encryption code to decode the code information Dk. When decoding of the code information Dk is accomplished, the car share device 23 determines that the code information Dk has been correctly received from the mobile terminal 22. When authentication is accomplished, the car share device 23 extracts the reservation date and time, the terminal ID, and the user authentication code.

When authentication of the code information Dk is accomplished, in step S104, the car share device 23 switches the electronic key function (key function unit 38) from an invalid state to a valid state. This allows the car share device 23 (key function unit 38) to execute electronic key ID verification through LF-UHF bidirectional communication with the verification ECU 9. In the present example, the car share device 23 stores the code information Dk (e.g., user authentication code) in the memory 36. After the code information Dk, which includes the user authentication code, is stored in the memory 36, the mobile terminal 22 and the car share device 23 both shift to an authentication completion state. This allows the mobile terminal 22 to be used in place of the electronic key 2 as an electronic key (vehicle key) of the vehicle 1.

Referring to FIG. 3, the user operates and activates an operation request button of the mobile terminal 22, which has been shifted to the authentication completion state, to transmit an operation request signal from the mobile terminal 22 to the car share device 23. The operation request button is, for example, shown on a display of the mobile terminal 22, and used to actuate the on-board device 3. The operation request button may be, for example, an unlock request button for unlocking the vehicle door 13, a lock request button for locking the vehicle door 13, an engine start button for starting the engine 6, or the like.

The UI application 30 of the mobile terminal 22 encrypts an operation request signal, which corresponds to the operation request button, with the user authentication code. In a non-restrictive example, the operation request signal may include a device actuation command corresponding to the operation request button. The UI application 30 of the mobile terminal 22 transmits the encrypted operation request signal to the car share device 23.

When the car share device 23 receives the operation request signal, the car share device 23 communicates with the verification ECU 9 of the electronic key system 4 and actuates the on-board device 3 in accordance with the received operation request signal. In a non-restrictive example, the car share device 23 establishes smart communication with the verification ECU 9 of the electronic key system 4 through the smart communication block 34 and sends a device actuation command and the electronic key ID to the verification ECU 9. The verification ECU 9 performs electronic key ID verification and sends the device actuation command to the ECU of the corresponding on-board device when the electronic key ID verification is accomplished to actuate the corresponding on-board device 3.

For example, if the device actuation command is an unlock request command for the vehicle door 13, the body ECU 10 actuates the door lock device 5 to unlock the vehicle door 13. If the device actuation command is a lock request command for the vehicle door 13, the body ECU 10 actuates the door lock device 5 to lock the vehicle door 13. If the device actuation command is a starting request command for the engine 6, the engine ECU 11 permits starting of the engine 6. For example, if the engine switch 18 is operated when the brake pedal is depressed, the engine ECU 11 starts the engine 6. In addition to electronic key ID verification, challenge-response authentication using the electronic key unique encryption code may be performed between the verification ECU 9 and the car share device 23 if necessary. In the same manner as the smart verification performed between the electronic key 2 and the verification ECU 9, smart verification may be performed between the car share device 23 and the verification ECU 9.

Returning to FIG. 1, the car sharing system 21 is applicable to a valet parking system for lending the vehicle 1 to a valet (i.e., asking for the vehicle to be parked). In the present example, when lending the vehicle 1 to a third person such as a valet, a valet key 41 is handed to the third person as the vehicle key (electronic key).

The valet key 41 includes a key control unit 42, operation portions 43, a first communication module 44, a second communication module 45, and a memory 46. The key control unit 42 controls the operation of the valet key 41. The operation portions 43 are used when the user operates the valet key 41. The first communication module 44 is used for wireless communication (in present example, Bluetooth communication) between the mobile terminal 22 and the valet key 41. The second communication module 45 is used for wireless communication (in the present example, Bluetooth communication) between the vehicle 1 (in the present example, the car share device 23) and the valet key 41. The memory 36 is, for example, a data rewritable memory and stores key information Dx. In the present example, the key information Dx is information used for authentication of the valet key 41 through communication with the car share device 23 and may be, for example, the code information Dk or the user authentication code.

The key information Dx is registered to the memory 46 to allow the valet key 41 to function as the vehicle key (electronic key) of the vehicle 1. In a non-restrictive example, the registration of the key information Dx to the valet key 41 is performed by requesting for the key information Dx from the valet key 41 via the mobile terminal 22 to the server 20 and obtaining the key information Dx from the server 20. Alternatively, the valet key 41 may directly obtain the key information Dx from the server 20.

In a non-restrictive example, the operation portions 43 include a lock operation portion 43a, which is operated the vehicle door 13, and an unlock operation portion 43b, which is operated to unlock the vehicle door 13. In the present example, the operation portions 43 further include a first operation portion 43c operated to initiate use of the valet key 41 (car sharing system 21) and a second operation portion 43d operated to terminate use of the valet key 41 (car sharing system 21). The operation portions 43a to 43d may be, for example, push buttons. The first operation portion 43c may be used, for example, when initiating near-distance wireless communication (Bluetooth communication) with the valet key 41. When use of the valet key 41 is initiated, the vehicle 1 can be used with the valet key 41. When use of the valet key 41 is terminated, the key function of the valet key 41 is invalidated and the vehicle 1 thereby cannot be used with the valet key 41.

The valet key 41 includes an operation guide function for notifying the user that an error has occurred in a user operation performed to actuate the vehicle 1. In the present example, upon detection of an operation error, the operation guide function transmits the operation error to an output device through a communication protocol allowing for communication with numerous unspecified communication peers to notify the user of the operation error. A non-restrictive example of the output device is the mobile terminal 22.

To implement the operation guide function, in a non-restrictive example, the valet key 41 includes an operation error monitoring unit 49 that monitors the occurrence of an operation error caused by the user when attempting the actuate the vehicle 1. The operation error monitoring unit 49 is included in the key control unit 42. For example, the valet key 41 includes one or more processors and a memory storing one or more commands. The one or more processors execute commands so that the key control unit 42 functions as the operation error monitoring unit 49.

For example, the operation error monitoring unit 49 determines that an operation error has occurred when a user operation is performed in a state in which the key information Dx is not registered in the valet key 41. The operation error monitoring unit 49 also determines that an operation error has occurred when a user operation is performed in a state in which the key function of the valet key 41 is not valid. In the present example, a user operation refers to an operation performed by the user on the valet key 41 and is the pushing or touching of an operation portion 43 (lock operation portion 43a, the unlock operation portion 43b, or the like). The key information Dx may be, for example, the code information Dk or the user authentication code. The operation error monitoring unit 49 is configured to check whether or not the key function of the valet key 41 is valid by, for example, checking whether or not the key control unit 42 has been activated or checking whether or not the key control unit 42 is in a valid state (operable based on key information Dx).

The valet key 41 includes a notification unit 50 that notifies the user of an operation error detected by the operation error monitoring unit 49. The notification unit 50 is included in the key control unit 42. The one or more processors of the valet key 41, for example, execute commands so that the key control unit 42 functions as the notification unit 50. The notification unit 50 transmits the operation error detected by the operation error monitoring unit 49 to an output device 51 (in the present example, mobile terminal 22) through a communication protocol allowing for communication with numerous unspecified communication peers to notify the user of the operation error to have the output device 51 issue a notification corresponding to the operation error. The communication protocol allowing for communication with numerous unspecified communication peers may be, for example, broadcast communication. Notification corresponding to the operation error (hereafter, operation error notification) includes, for example, notification of the content of an operation error and notification of the correct operation procedure.

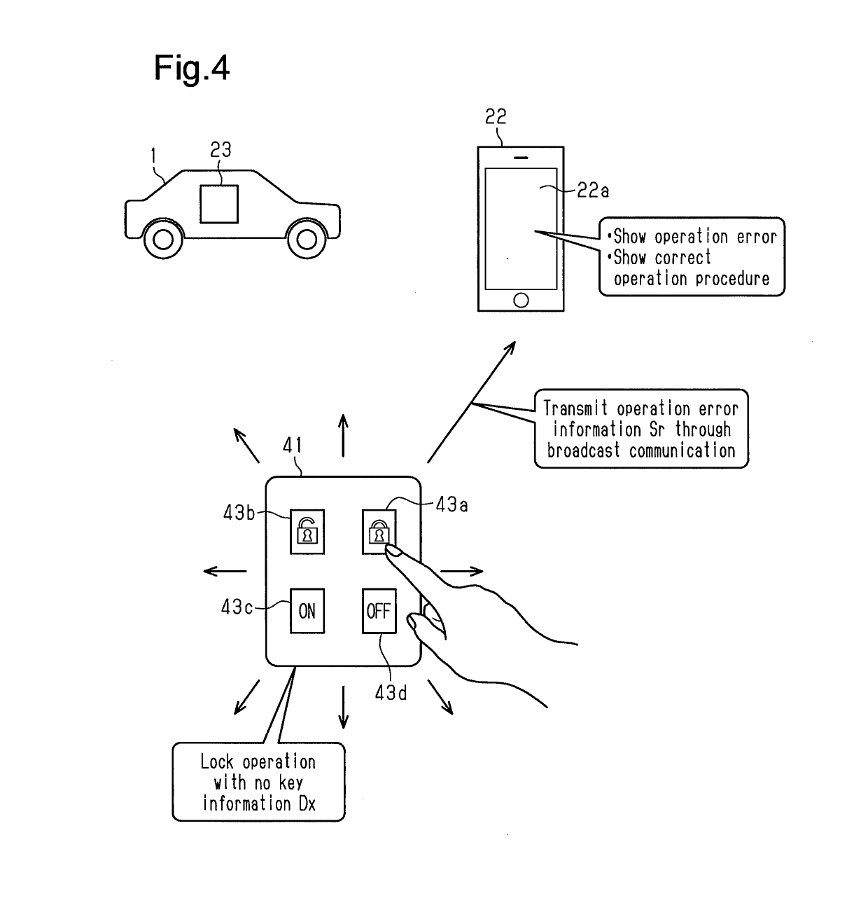

The operation of the car sharing system 21 and the valet key 41 will now be described with reference to FIG. 4.

FIG. 4 illustrates an example of an operation error notification. For example, when the key information Dx is not registered to the valet key 41, the valet key 41 is not actuated even when the valet key 41 (operation portion 43 such as lock operation portion 43a or unlock operation portion 43b) is operated. In the same manner, when the key function of the valet key 41 is not valid, the valet key 41 is not actuated even when the valet key 41 is operated.

In such case, the operation error monitoring unit 49 determines that the valet key 41 has not been correctly operated and outputs an operation error detection notification to the notification unit 50.

In response to the operation error detection notification from the operation error monitoring unit 49, the notification unit 50 transmits an operation error to the output device 51. In the present example, the notification unit 50 sends the operation error information Sr to the mobile terminal 22 through broadcast communication. For example, the notification unit 50 puts the operation error information Sr into packets transmitted through wireless communication with the mobile terminal 22. One example of such a packet is an advertising packet transmitted from the valet key 41 when the valet key 41 is Bluetooth-connected to the mobile terminal 22. The operation error information Sr includes information notifying the operation error content (e.g., operation portion 43 operated in state in which key information Dx is not registered to valet key 41) and information notifying correct operation procedure.

In broadcast communication, the operation error information Sr is not only transmitted to the mobile terminal of a specified user (i.e., mobile terminal 22) but also transmitted to the mobile terminal of any other user using the same application. Thus, to find the valet key 41 that transmitted the operation error information Sr, identification information may be transmitted together with the operation error information Sr. For example, the car share device ID may be used as the identification information. For example, when registering the code information Dk to the mobile terminal 22, the car share device ID is stored in the memory 29 of the mobile terminal 22. In the same manner, the car share device ID is stored in the memory 46 of the valet key 41. The car share device ID associates the mobile terminal 22 with the valet key 41 (also car share device 23, that is, vehicle 1). The valet key 41 (notification unit 50) transmits (broadcasts) the car share device ID together with the operation error information Sr. Thus, the car share device ID allows the mobile terminal 22 to find the valet key 41 associated with the mobile terminal 22. Accordingly, the mobile terminal 22 receives the operation error information Sr from the corresponding valet key 41.

The mobile terminal 22 is configured to constantly receive the advertising packet. Accordingly, when the operation error information Sr is transmitted from the valet key 41, the mobile terminal 22 receives the operation error information Sr. The mobile terminal 22 issues an operation error notification based on the received operation error information Sr. In the present example, the operation error notification includes notification of the operation error content and notification of the correct operation procedure. Such notifications may be shown on a display 22a of the mobile terminal 22.

The notification of the operation error content is a message shown on the display 22a such as “valet key is invalid and cannot lock vehicle door.” The notification of the correct operation procedure is a message shown on the display 22a such as “perform operations in following order.” Thus, when an error occurs in a user operation performed on the valet key 41, the user can easily and readily recognize the operation error content and correct operation procedure from the message shown on the display 22a of the mobile terminal 22 of the user.

For example, when the key information Dx is not registered to the valet key 41, the user can operate the first operation portion 43c of the valet key 41 following the guidance shown on the display 22a of the mobile terminal 22. In this case, the valet key 41 is BLE-connected via the first communication module 44 to the mobile terminal 22 in order to acquire the key information Dx or validate the key function.

In a non-restrictive example, the valet key 41 acquires the key information Dx from the server 20 via the mobile terminal 22. For example, the valet key 41 sends a key information acquisition request to the mobile terminal 22, and the mobile terminal 22 sends the key information acquisition request to the server 20. Then, the server 20 generates the key information Dx for the valet key 41, which sent the key information acquisition request. The key information Dx is sent via the mobile terminal 22 to the valet key 41. In this case, preferably, the key information Dx registered to the valet key 41 is code information Dk that has newly been generated in the server 20 or the user authentication code.

Alternatively, when the key information Dx that is to be registered to the valet key 41 has already been stored in the mobile terminal 22, the valet key 41 may directly acquire the key information Dx from the mobile terminal 22 instead of acquiring new key information Dx from the server 20. For example, the mobile terminal 22 acquires the key information Dx for the valet key 41 together with the code information Dk from the server 20. In this case, there is no need to establish communication between the server 20 and the mobile terminal 22. This facilitates the registration of the key information Dx to the valet key 41.

Further, the valet key 41, for example, authenticates the key information Dx through communication via communication with the mobile terminal 22 (or server 20) to switch the key function of the valet key 41 from an invalid state to a valid state. In the present example, after the key information Dx acquired by the valet key 41 validates the key function of the valet key 41, near-field wireless communication (BLE communication) is established between the valet key 41 and the vehicle 1. This allows the valet key 41 to be used as the vehicle key.

The valet key 41 of the present embodiment has the advantages described below.

The valet key 41 includes the operation error monitoring unit 49 and the notification unit 50. The operation error monitoring unit 49 monitors whether an error has occurred in a user operation performed to actuate the vehicle 1. When the operation error monitoring unit 49 determines that an operation error has occurred, the notification unit 50 transmits the operation error to the output device 51 to have the output device 51 issue a notification corresponding to the operation error. The notification issued by the output device 51 allows the user to properly recognize the operation error.

In the present example, the output device 51 is the mobile terminal 22, and the operation error is an error in a user operation performed on the valet key 41. In this case, the notification unit 50 transmits an error in a user operation performed on the valet key 41 to the mobile terminal 22 to have a notification corresponding to the operation error issued on the display 22a of the mobile terminal 22. The notification shown on the display 22a of the mobile terminal 22 allows the user to readily recognize the operation error of the valet key 41. The notification of an operation error includes notification of the operation error content and notification of the correct operation procedure. Thus, even if the user is not familiar with how to use the valet key 41, the user will be able to recognize the operation error content and easily operate the valet key 41 in accordance with the correct operation procedure.

The notification unit 50 transmits the operation error information Sr to the mobile terminal 22 through broadcast communication. With this configuration, an operation error is transmitted to the mobile terminal 22 even before the valet key 41 is connected to near-field wireless communication. Thus, when an operation error occurs, the user can readily recognize the operation error. For example, when a communication peer has to be specified like in unicast communication, communication connection takes time. Thus, time would be required for the user to be notified of the operation error transmitted to the mobile terminal 22. Such a situation does not occur with broadcast communication. In broadcast communication, the operation error information Sr is transmitted not only to the mobile terminal 22 but also to nearby mobile terminals. Further, the operation error information Sr includes only operation information and does not include confidential information such as authentication information. This avoids security problems. Further, data communication occurs less frequently in broadcast communication than unicast communication. This reduces the consumed current.

An error in a user operation performed on the valet key 41 is notified to the mobile terminal 22 of the user. This eliminates the need for a new or additional device and thereby reduces costs.

The operation error monitoring unit 49 determines that an operation error has occurred when the valet key 41 is operated in a state in which the key information Dx is not registered to the valet key 41 or when the valet key 41 is operated in a state in which the key function is not valid. Thus, when an error occurs in an operation performed on the valet key 41, the user can readily recognize the operation error.

The valet key 41 is suitable for use with the vehicle 1 included in the car sharing system 21. In the car sharing system 21, the mobile terminal 22 is used as the vehicle key to operate the vehicle 1. When using valet parking service with the car sharing system 21, the user does not have to hand the mobile terminal 22 to a third person. The user hands the valet key 41 to the third person. The valet key 41 is seldom used. Thus, an operation error may occur when using the valet key 41. For example, when the user is not familiar with how to use the valet key 41, an operation error is likely to occur. In this regard, when an error occurs in a user operation performed on the valet key 41, the user is notified of the operation error. In the present example, the operation error is shown on the display 22a of the mobile terminal 22, and the user thereby readily recognizes the operation error. Thus, even when the user seldom uses the valet key 41, the user will properly be notified of the operation error.

The vehicle 1 of the car sharing system 21 is not limited to a typical commercial vehicle and may be an automobile shared by a group such as a family. In this case, for example, if a family member (family user) other than the main user, who is the owner of the vehicle 1, uses the vehicle 1, a vehicle usage request is transmitted from the mobile terminal 22 of the family user to the mobile terminal 22 of the main user. When the mobile terminal 22 of the main user receives the vehicle usage request and the main user operates the mobile terminal 22 to permit use of the vehicle 1, the mobile terminal 22 of the main user transmits usage permission to the mobile terminal 22 of the family user.

After the usage permission is transmitted to the mobile terminal 22 of the family user, the mobile terminal 22 of the family user (or mobile terminal 22 of main user) acquires the code information Dx from the server 20 and registers the code information Dx to the mobile terminal 22 of the family user. For example, the server 20 generates the code information Dk that is registered to the mobile terminal 22 of the family user and transmits the code information Dk to the mobile terminal 22 through network communication. The code information Dk may include a reservation time and date, a terminal ID of the mobile terminal 22 of the family user, and user authentication code registered to the mobile terminal 22 of the family user. Preferably, the code information Dk is transmitted as encrypted data from the server 20 to the mobile terminal 22 of the family user.

When receiving the code information Dk from the server 20, the mobile terminal 22 of the family user writes the code information Dk to the memory 29. As a result, the mobile terminal 22 of the family user becomes operable as the vehicle key. In this manner, the vehicle 1 can be shared by members of a group such as a family.

It should be apparent to those skilled in the art that the foregoing embodiments may be implemented in many other specific forms without departing from the scope of this disclosure. Particularly, it should be understood that the foregoing embodiments may be implemented in the following forms.

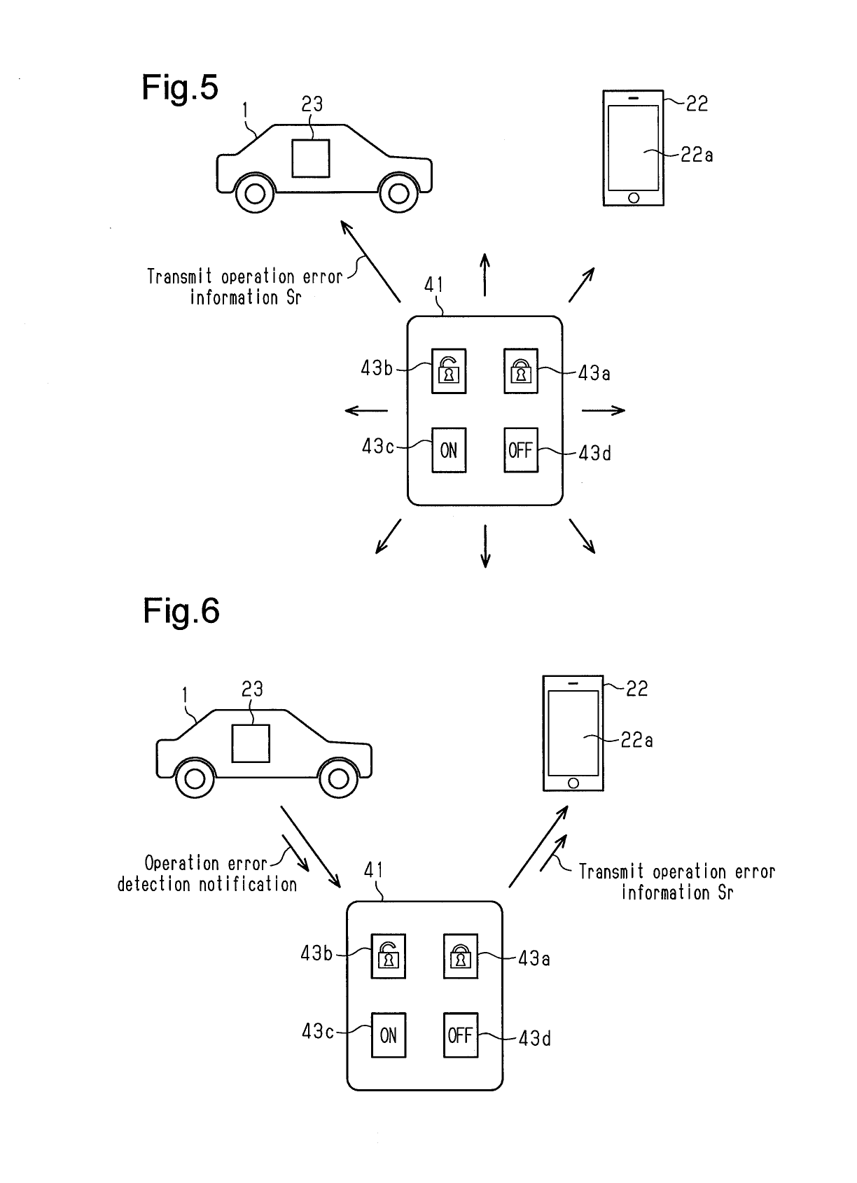

The output device 51 is not limited to the mobile terminal 22. For example, the output device 51 may be the vehicle 1 (any suitable on-board device) or the car share device 23. FIG. 5 illustrates another example of an operation error notification transmitted from the valet key 41. As illustrated in FIG. 5, the valet key 41 transmits the operation error information Sr through broadcast communication to the vehicle 1 or the car share device 23 so that the vehicle 1 or the car share device 23 issues a notification corresponding to the operation error. For example, the operation error information Sr is transmitted by the second communication module 45 of the valet key 41 to the car share device 23 of the vehicle 1. The car share device 23 (or any suitable on-board device of vehicle 1) issues an operation error notification. In such a case, the user can properly recognize an error in the operation performed by the user on the valet key 41.

The operation error notification resulting from the operation guide function may be issued by both the mobile terminal 22 and the car share device 23. This further ensures that the user will be notified of the error in the user operation performed on the valet key 41.

As illustrated in FIG. 6, the vehicle 1 or the car share device 23 may detect an operation error in a user operation performed to actuate the vehicle 1 and transmit an operation error detection notification to the valet key 41. In this case, when receiving the operation error detection notification from the vehicle 1 or the car share device 23, the operation error monitoring unit 49 of the valet key 41 determines that an operation error has occurred. The notification unit 50 of the valet key 41, for example, transmits an operation error through broadband communication to the output device (i.e., mobile terminal 22) to have the output device issue a notification corresponding to the operation error. For example, in a case in which a user operation is directly performed on the vehicle 1 instead of with the valet key 41 in a state in which the key information Dx is not registered to the valet key 41 or a state in which the key function of the valet key 41 is not valid, the vehicle 1 (or car share device 23) detects the operation error. Further, an operation error may also be detected when a user operation is performed on the vehicle 1 in a state in which the electronic key function (key function unit 38) of the car share device 23 is not valid. One example of a user operation performed on the vehicle 1 is an operation directly performed on a lock button of an exterior door handle to lock the vehicle door. With this configuration, when an operation error in a user operation performed on the vehicle 1 occurs, the output device notifies the user of the operation error content or the correct operation procedure through the output device in the same manner as the above embodiment.

The condition for determining that an error has occurred in a user operation performed on the valet key 41 is not limited to the condition of the above embodiment. For example, an operation error may be detected when any other condition is satisfied such as when an operation order of the operation portions 43 for validating the valet key 41 is erroneous.

The output device 51 is not limited to the mobile terminal 22 or the car share device 23 (vehicle 1) and any other device or terminal may be used as the output device 51.

The communication protocol allowing for communication with numerous unspecified communication peers is not limited to broadcast communication and may be another communication protocol allowing for communication with numerous unspecified communication peers.

Communication between the mobile terminal 22 and the valet key 41 is not limited to Bluetooth communication and may be another communication protocol.

In the valet key 41, the first communication module 44 and the second communication module 45 do not have to be configured as separate module components and may be configured as a single module component.

The valet key 41 is not limited to the configuration of the above embodiment and may have any configuration.

The mobile terminal 22, the car share device 23, and the valet key 41 may acquire the user authentication code through any procedure or process.

The code information Dk does not have to be encrypted by the car share device unique encryption code and may be encrypted by any other encryption code.

The content of the code information Dk can be changed to one other than that of the above embodiment.

The code information Dk does not have to be generated by the server 20 and may be generated by any other external device.

The condition for switching the key function unit 38 from an invalid state to a valid state is not limited to the condition described above and may be any other condition.

The engine 6 may be started by, for example, operating an “engine start” button shown on the display of the mobile terminal 22.

In the smart verification of the key-operation-free system (electronic key system 4), the exterior transmitter and the interior transmitter do not have to be used to determine whether the electronic key 2 is located inside the vehicle 1 or outside the vehicle 1. For example, left and right antennas (LF antennas) may be arranged on the vehicle body, and the combination of the response of the electronic key 2 to the radio waves transmitted from each antenna may be checked to determine whether the electronic key 2 is located inside the vehicle 1 or outside the vehicle 1.

The smart verification of the electronic key system 4 does not have to perform both electronic key ID verification and challenge-response verification. As long as electronic key ID verification is performed, any verification process may be performed. Further, any verification may be performed in lieu of the challenge-response verification.

In the electronic key system 4, instead of using the verification ECU 9, the electronic key 2 may initiate wireless communication and execute electronic key ID verification.

The electronic key 2 is not limited to a Smart Key (registered trademark) and may be any other wireless key.

The near-field wireless communication is not limited to Bluetooth communication and may be of any type of communication protocol.

The code information Dk is not limited to a one-time key and may be any information of which use is restricted.

The encryption code used for encrypted communication may be, for example, any one of the car share device unique encryption code, the user authentication code, and the electronic key unique encryption code. For example, the encryption code used during a process may be switched to improve communication security.

Communication between the verification ECU 9 (electronic key system 4) and the car share device 23 is not limited to wireless communication and may be wired communication.

There is no limit to where the car share device 23 can be installed.

The mobile terminal 22 is not limited to a smartphone and may be any other mobile terminal.

All examples and conditional language recited herein are intended for pedagogical purposes to aid the reader in understanding the principles of the invention and the concepts contributed by the inventors to furthering the art, and are to be construed as being without limitation to such specifically recited examples and conditions, nor does the organization of such examples in the specification relate to an illustration of the superiority and inferiority of the invention. Although embodiments have been described in detail, it should be understood that various changes, substitutions, and alterations could be made hereto without departing from the scope of this disclosure.

1. A valet key usable as a vehicle key when lending a vehicle to a third person, the valet key comprising:
an operation error monitoring unit configured to monitor whether or not an operation error has occurred in a user operation performed to actuate the vehicle; and
a notification unit configured to have an output device issue a notification corresponding to the operation error, when the operation error monitoring unit determines that the operation error has occurred, by transmitting the operation error to the output device through a communication protocol allowing for communication with numerous unspecified communication peers.

2. The valet key according to claim 1, wherein
the output device includes a mobile terminal that is usable as the vehicle key, and
the notification unit shows the notification corresponding to the operation error on a display of the mobile terminal.

3. The valet key according to claim 1, wherein the notification corresponding to the operation error is a notification of a content of the operation error and a notification of a correct operation procedure.

4. The valet key according to claim 1, wherein the operation error monitoring unit determines that the operation error has occurred when the valet key is operated in a state in which key information is not registered to the valet key or when the valet key is operated in a state in which a key function of the valet key is not valid.

5. The valet key according to claim 1, wherein
the valet key is used in a car sharing system for the vehicle,
the car sharing system includes a car share device configured to perform wireless communication with a mobile terminal that functions as a vehicle key when code information is registered to the mobile terminal, and
the car share device is configured to authenticate the code information through wireless communication with the mobile terminal and permit actuation of an on-board device of the vehicle with an electronic key system of the vehicle if the mobile terminal is operated after the code information is authenticated.

6. A method for controlling a valet key usable as a vehicle key when lending a vehicle to a third person, the method comprising:
monitoring whether or not an operation error has occurred in a user operation performed to actuate the vehicle; and
having an output device issue a notification corresponding to the operation error, when determined that the operation error has occurred, by transmitting the operation error to the output device through a communication protocol allowing for communication with numerous unspecified communication peers.
